(19) United States
(12) Patent Application Publication
(10) Pub. No.: US 2024/0341342 A1
(43) Pub. Date: Oct. 17, 2024

(54) HIGH EFFICANCY HYDRATION COMPOSION, PRODUCTION METHOD, AND USE.

(71) Applicant: Paul Knox, Orlando, FL (US)

(72) Inventor: Paul Knox, Orlando, FL (US)

(21) Appl. No.: 18/299,042

(22) Filed: Apr. 11, 2023

(51) Int. Cl. A23L 33/00; A23L 33/105; A23L 33/15; A23L 33/16; A23L 33/165; A23L 33/175

(52) U.S. Cl. CPC A23L 33/30; A23L 33/105; A23L 33/15; A23L 33/16; A23L 33/165; A23L 33/175

(57) ABSTRACT

The invention relates generally to health supplements, and more particularly to a hydration composition for use in the human body. In recent decades, the identification of sodium-glucose transporters, and other dynamic physiological mechanisms responsible for fluid absorption, have led to advances in hydration therapies. In the past, hydration products attempting to capitalize on these advances in re-hydration have been high in sugar and/or sodium content. As the public becomes more health conscious, other contaminates pose additional concerns. Examples of concerning contaminants which may be included in ingredients of current re-hydration treatments are genetically modified organisms (GMO), inorganic pesticides, or gluten. The disclosed composition, use, and system of production are directed to overcoming one or more of the problems set forth above and/or other problems found in the prior art.

### TECHNICAL FIELD

The invention relates generally to health supplements, and more particularly to hydration compositions for use in the human body.

### BACKGROUND

Dehydration occurs when the body loses more fluids than are taken in over a given period of time, and may have serious impacts on the human body's ability to function. These problems may include difficulty maintaining the balance of water and other nutrient levels across tissues. In fact, cases of dehydration caused by viruses such as cholera are a major source of hospitalization in many parts of the developing world. Anyone can become dehydrated, and even mild dehydration may cause unpleasant symptoms such as headache and fatigue.

In recent decades, the identification of sodium-glucose transporters, and other dynamic physiological mechanisms responsible for fluid absorption, have led to advances in hydration therapies. Oral rehydration therapies, consisting of the administration of solutions containing glucose and electrolyte, are common treatments for dehydration in cases of hospitalization. These treatments while beneficial, continue to undergo refinement to avoid gastrointestinal upset while optimizing net fluid absorption.

In the past, hydration products attempting to capitalize on these advances in re-hydration have been high in sugar and/or sodium content. Excess sugars add empty calories to the diet of the user. Further, the sugars in these drinks may themselves negatively impact the benefits of any electrolytes contained within them, actually slowing hydration rates. As the public becomes more health conscious, other contaminates pose additional concerns. Examples of concerning contaminants of current re-hydration treatments are genetically modified organisms (GMO), inorganic pesticides, and gluten. The disclosed composition, use, and system of production are directed to overcoming one or more of the problems set forth above, and/or other problems found in the prior art.

### SUMMARY

In one aspect, the present disclosure is directed to novel oral hydration compositions. Disclosed oral hydration compositions may include an agglomerate compound infused with micronutrients and flavoring compounds. Once formed, the infused agglomerate may be dissolved into a solution with constituent materials suspended therein.

In another aspect, the present disclosure is directed to a method of treating dehydration with a disclosed oral hydration composition. Disclosed hydration compositions may be prepared as a solution for delivery by oral ingestion to a user. Once delivered, disclosed solutions may increase the efficiency of rehydration among one or more tissues of a user, and overall rates of rehydration.

In yet another aspect, the present disclosure is directed to a method of producing disclosed oral hydration compositions.

### BRIEF FIGURE DESCRIPTION

FIG. 1 depicts an isometric illustration of a disclosed hydration composition delivery system.

FIG. 2 depicts a flow chart of a method of production of a disclosed hydration composition.

FIG. 3 depicts a diagrammatic representation of Step 1 of a method of production of a disclosed hydration composition.

FIG. 4 depicts a diagrammatic representation of Step 2 of a method of production of a disclosed hydration composition.

FIG. 5 depicts a diagrammatic representation of Step 3 of a method of production of a disclosed hydration composition.

FIG. 6 depicts a diagrammatic representation of Step 4 of a method of production of a disclosed hydration composition.

### DETAILED DESCRIPTION

Aspects of the present disclosure are best understood when read in conjunction with the accompanying figures. As is standard industry practice, various features may not be drawn to scale. Depictions thereof may be increased, or decreased, for clarity.

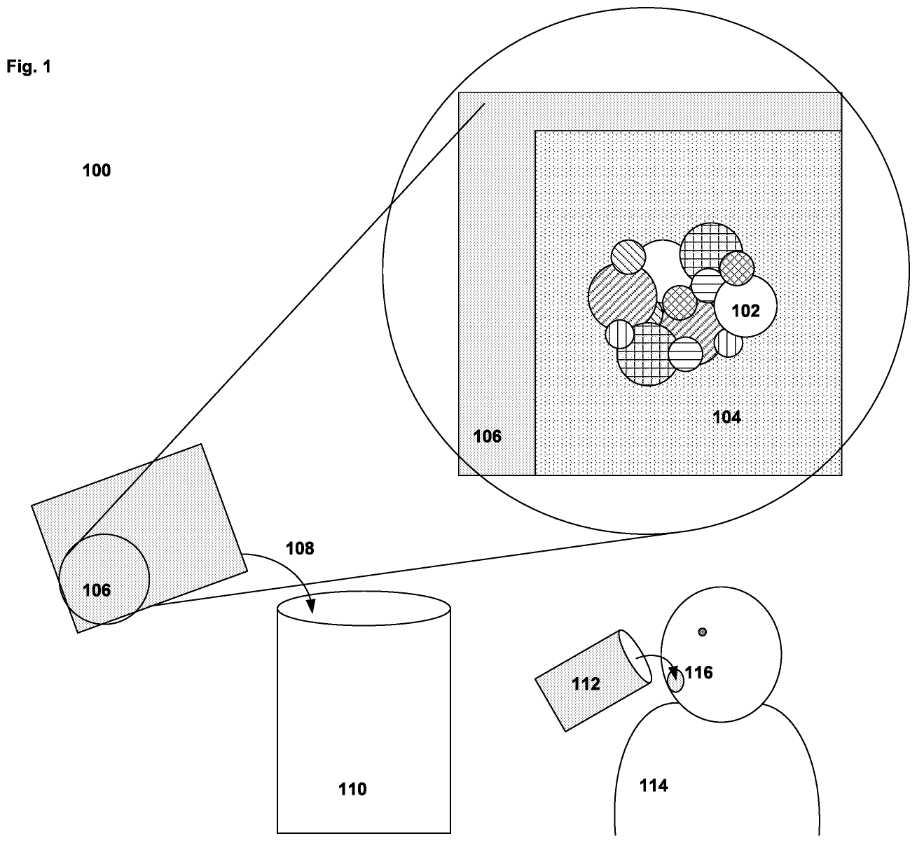

FIG. 1 depicts an isometric illustration of a disclosed hydration composition delivery system. FIG. 1 may include an exemplary oral hydration delivery environment (“environment”) 100. Environment 100 may be any location where an individual may experience dehydration such as a: home, worksite, hospital, sports match, park, wilderness, and the like. While described and illustrated in this disclosure with respect to home use, it will be readily apparent to those skilled in the art that the disclosed hydration system may also be effectively deployed in other environments.

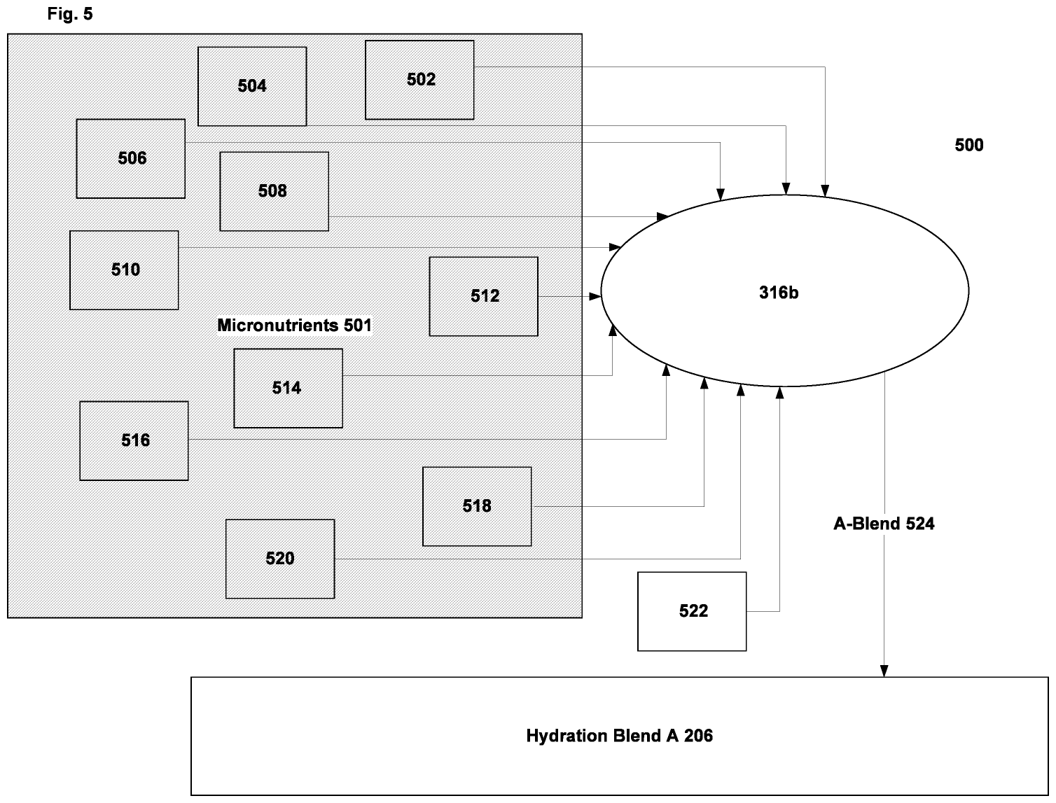

Environment 100 may include hydration blend B 104. A primary component of hydration blend B 104 may be ElectraCell 102. Environment 100 may additionally include water 110, and user 114. User 114 may be a human individual who may become dehydrated. ElectraCell 102 may act as a carrier of additional infused component powdered micronutrients 501(See FIG. 5). ElectraCell 102, itself infused with micronutrients 501, may collectively be referred to as hydration blend B 104. ElectraCell 102 may also act as a carrier of micronutrients 501 into solution 112.

Herein the word ‘component’ may be used to describe a species of particulate powder comprising predominately a single material, or a precursor product blend of an approximately homogenous composition, which may be used as an ingredient in a disclosed hydration composition. ‘Powder’, and ‘powdered,’ herein are used to describe fine, dry, approximately homogenous compositions of collections of particulate matter; and fine, dry, approximately homogenous particulate matter precursor blends. Unless otherwise indicated, particle size of said particulate matter may be less than required to pass through a standard 100 size mesh (each whole approximately 149 microns in diameter).

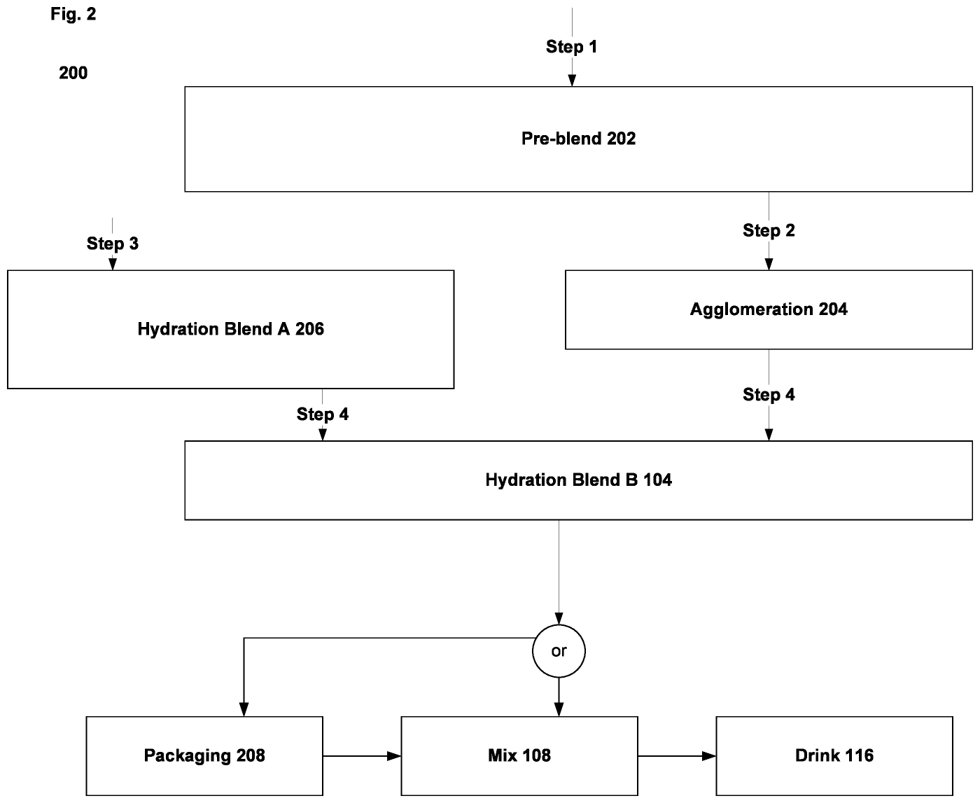

Hydration blend B 104 may be packaged 208 (shown in FIG. 2) into a package 106. Hydration blend B 104 through mixing 108 with water 110 may become oral rehydration solution (“solution”) 112. After mixing 108, hydration blend B 104 may be dissolved with components suspended in water 110, and collectively referred to as solution 112.

Generally, solutions may be characterized as ‘Hypotonic’, ‘Isotonic’, or ‘Hypertonic.’ ‘Hypertonic’ may be used to characterize a solution having a higher osmotic pressure than a particular fluid, typically a body fluid or intracellular fluid. ‘Isotonic’ may be used to characterize a solution having the same osmotic pressure as some other solution, especially one in a cell or a body fluid. ‘Hypotonic’ may be used to characterize a solution having a lower osmotic pressure than a particular fluid, typically a body fluid or intracellular fluid.

While hydration solutions may be found in the prior art, these solutions may be hypertonic. Solution 112 may be hypotonic. Solution 112 may be administered orally (“drink”) 116 by user 114. User 114 may drink 116 solution 112 allowing for delivery of hydration blend B 104 to the digestive tract (not shown) of user 114. As a hypotonic solution, solution 112 may be better tolerated by the digestive system of user 114. User 114 may drink 116 solution 112 before, during, or after exercise; or at any time of day regardless of physical exertion.

The digestive tract of user 114 may then rapidly deliver components of hydration blend B 104, to blood and tissues (not shown) of user 114. Once present in the blood and tissues of user 114, components of hydration blend B 104 may cause a change to localized hypotonic qualities of the interstitial fluid of said tissues of user 114. Localized hypotonic qualities of said tissues' interstitial fluid, may change overall osmolality. Osmolality refers to the measurement of concentrations of chemical particles found in the fluid part of blood and tissues.

Net fluid absorption across the membranes comprising tissues of user 114 may be increased by changes to osmolality of the interstitial fluid and tissues (not shown) of user 114. Hypotonic and osmolality related physiological changes to tissues throughout the system of user 114 may increase overall rates of rehydration of user 114. Increased rates of rehydration may allow more efficient: uptake of water 110, any other water not part of solution 112 user 114 may drink 116 in rapid succession before or after solution 112, any water not part of solution 112 user 114 may later drink 116 while hydration blend B 104 may be found in the physiological systems of user 114, or re-allocation of any other sources of water stored within other tissues of user 114.

Package 106 may hold a single serving of hydration blend B 104, or multiple servings allowing later metering and/or withdrawal of individual servings, to use during mixing 108. An individual serving size package 106 of hydration blend B 104 may allow for additional ease during mixing 108. Servings may be approximately 6 g, but may range from 5.46 g to 6.82 g.

Package 106 may be composed of any material conducive to dry storage of powders for example: plastic, foil, cellulose, etc. A person having ordinary skill in the art would recognize package 106 may be composed of a wide verity of polymers and other materials. Package 106 may take the form of primary packaging (consumer or retail packaging). A person having ordinary skill in the art would also recognize package 106 may also be further compiled into numerous secondary, tertiary, and other packaging units.

Mixing 108 may comprise combination of hydration blend B 104 with water 110. Mixing 108 may, but need not, occur in combination with stirring, shaking, or any other action understood by those having skill in the art to assist the suspension rates of soluble dissolving powders. One of the benefits of hydration blend B 104 over the prior art, may be ease of transition from solid powder structure to dissolved separate components, comprising a suspension as solution 112.

Water 110 may comprise potable water of a sufficient amount so as to allow for suspension of a serving of hydration blend B 104, up to and including solution 112 becoming saturated with hydration blend B 104. An additional consideration may be ease of user 114 to readily drink 116 solution 112. The phrases ‘potable water’ and ‘water’ may be used throughout herein to describe an edible precursor solution comprising predominantly oxygen hydride consisting of an oxygen atom covalently bonded to two hydrogen atoms (H₂O). Examples of water 110 may include disposable prepackaged individual serving water bottles (typically sold in 8 fl oz.; 12 fl oz.; 16.9 fl oz.; or 20 fl oz.), a personal reusable water bottle containing potable water, personal water glass containing potable water, or the like.

While obviously any water 110 user 114 may ingest would itself be helpful in the treatment of dehydration, the purpose of water 110 herein is for the formation of solution 112. Formation of solution 112 may allow user 114 to drink 116 hydration blend B 104. Ingestion of hydration blend B 104 may occur directly (for example in pill form, etc.). However, those with skill in the art recognize solution 112, comprising dissolved components of hydration blend B 104, may be more readily absorbed and utilized by the body of user 114.

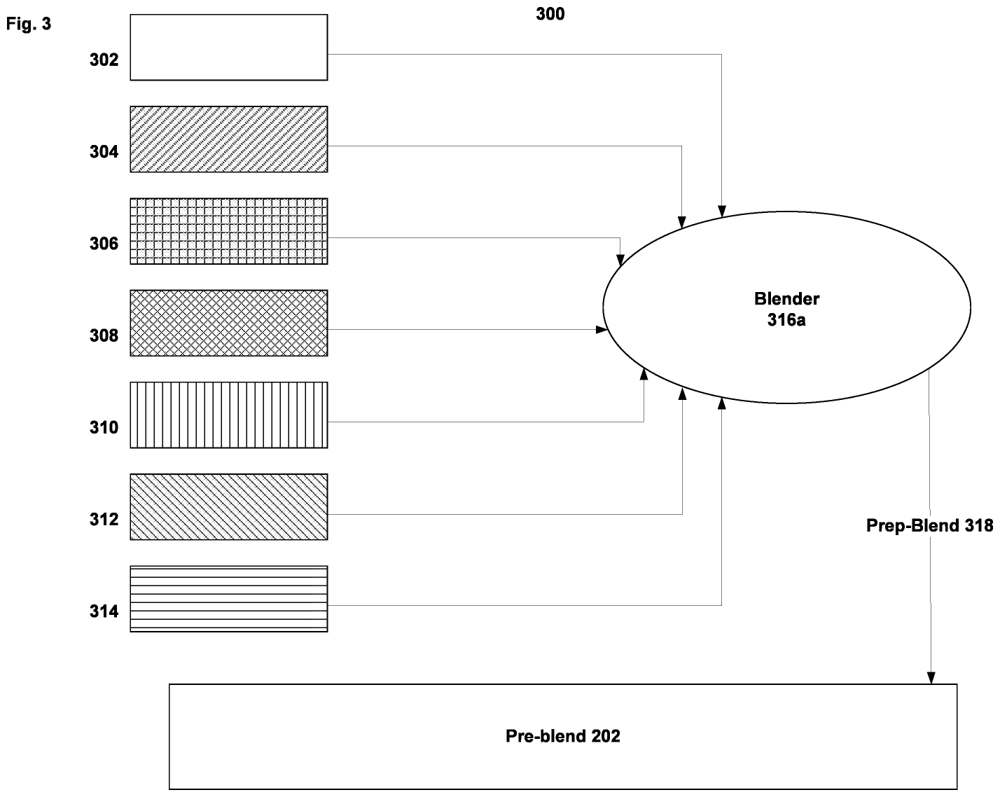

FIG. 2 depicts a flow chart of a method of production of a disclosed hydration composition. The method shown in FIG. 2 may take place in production facility 200. Production of hydration blend B 104 may consist of a series of separate steps, themselves further discussed in relation to the following figures (FIG. 3-6). It should be appreciated production facility 200 may also be environment 100.

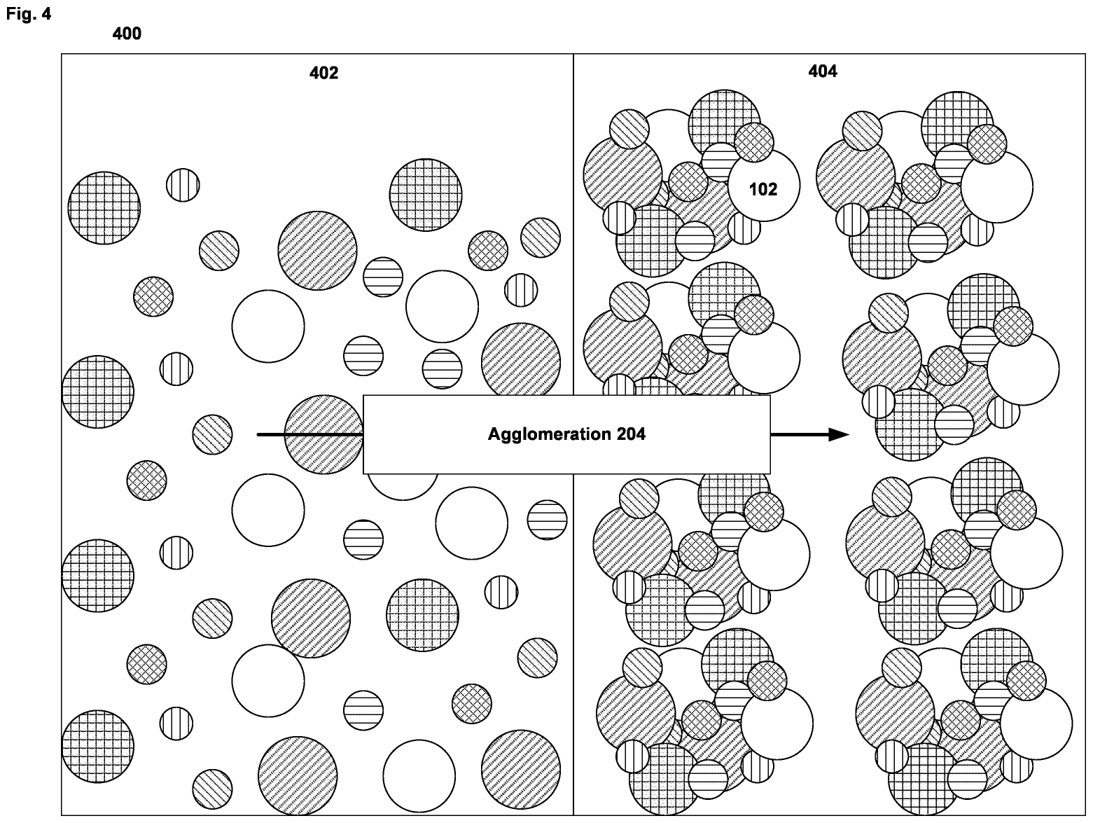

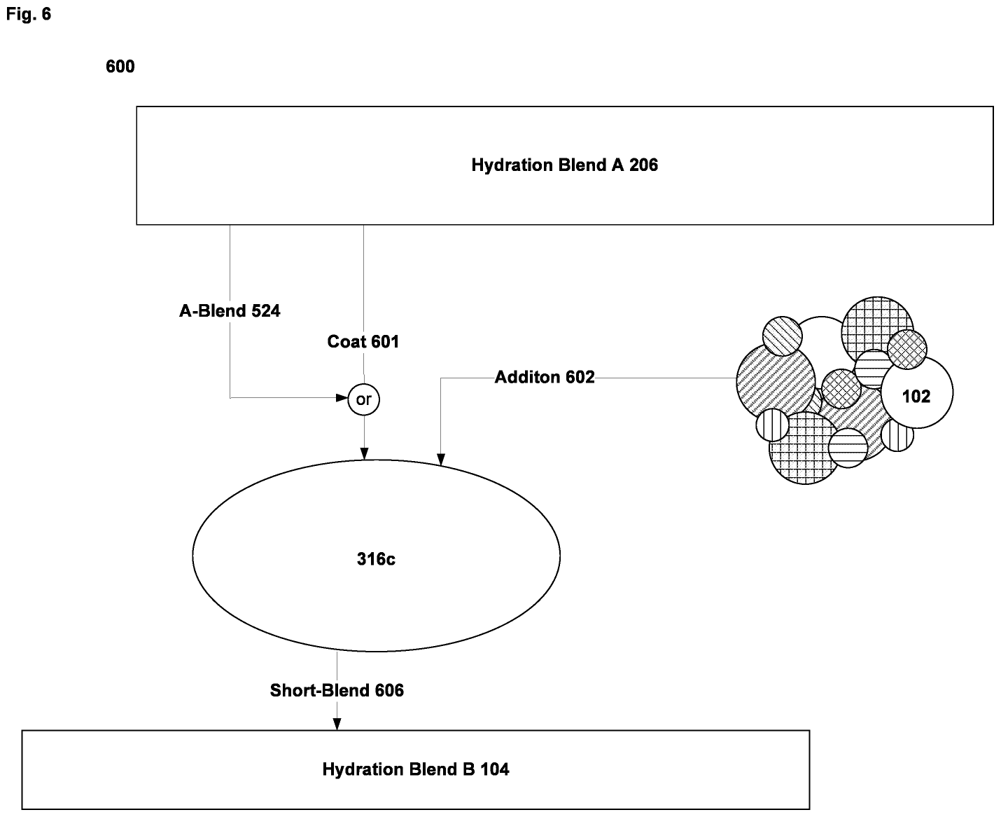

Step 1 of the production of hydration blend B 104 may begin with preparation of pre-blend 202 (shown in more detail in FIG. 3). Pre-blend 202 in Step 2 may undergo agglomeration 204 (discussed further in relation to FIG. 4) becoming ElectraCell 102. Separately, Step 3 may include preparation of hydration blend A 206 (discussed further in relation to FIG. 5). In Step 4, hydration blend B 104 may be produced from infusing ElectraCell 102 with hydration blend A 206 (discussed further in relation to FIG. 6).

Once formed, hydration blend B 104 may be a shelf stable, highly soluble, flowable powder ready for mixing 108. The properties of hydration blend B 104 lend itself to packaging 208 into one or more package 106(discussed in relation to FIG. 1). Packaging 208 may comprise loading package 106 with hydration blend B 104. Packages 106, once opened, may allow hydration blend B 104 to be combined with water 110 during mixing 108, prior to being served to drink 116. Alternatively, once formed hydration blend B 104 may proceed directly to mixing 108 before to being served to drink 116.

Hydration blend B 104 may allow for more ready production of standardized concentrations of each component of hydration blend B 104 in differing batches of solution 112, than from merely mixing of components of hydration blend B 104 directly with water 110. Flowability of ElectraCell 102, infused with micronutrients 501, may be more readily poured in desired proportions than pouring a blend of components of hydration blend B 104 directly. A composite powder alone may flow less efficiently than hydration blend B 104. Further in a composite powder, fine component particles may sift through, or under, courser component particles causing uneven proportions of composite powder components to enter water 110 during mixing 108.

Production facility 200 may be a kitchen, laboratory, manufacturing facility, or any other location suitable for the blending and/or production of approximately uniform powders. Production facility 200 may be comprised of a single environment wherein preparation-facility 300(discussed in relation to FIG. 3), agglomeration-facility 400(discussed in relation to FIG. 4), Ablend-facility 500(discussed in relation to FIG. 5), and shortblend-facility 600(discussed in relation to FIG. 6) may share a single location. With some loss of efficacy, each facility 300-600 may be divided among distinct locations.

FIG. 3 depicts a diagrammatic representation of Step 1 of a method of production of a disclosed hydration composition. Preparation-facility 300 (introduced in discussion of production facility 200 of FIG. 2) may be a location suitable for the blending and/or production of approximately uniform powders. Preparation-facility 300 may include a powder blending apparatus such as a ribbon blender (“blender”) 316, and separate powdered components of pre-blend 202. Pre-blend 202 may be a precursor component of a disclosed hydration composition (introduced above in relation to FIG. 2). References to blender 316 may include blenders 316a-c (shown on FIG. 3, FIG. 5, and FIG. 6 respectively). Blender 316a may comprise blender 316b, 316c, both, or neither.

Blender 316 may be a ribbon blender used for production of approximately uniform blends of powders. While the phrase ‘ribbon blender’ may be used throughout, persons having skill in the art would recognize blender 316 may also include any other similarly functioning agitator units designed for mechanical mixing actions. Such mechanical mixing actions designed to promote any of: shear resulting from particle-to-agitator, particle-to-wall, and particle-to-particle collisions; small-scale random motion (diffusion); and large-scale random motion (convection). Persons having skill in the art would recognize blender 316 may include any commonly available powder production blender such as ribbon blenders, double ribbon blenders, and paddle mixers.

Powdered components of pre-blend 202 may include: Rice Maltodextrin (“rice”) 302, Tapioca Maltodextrin (“tapioca”) 304, Apple Cider Vinegar Powder (“cider”) 306, L-Glycine 308, a powder comprising branched chain amino acids in two parts leucine, one part isoleucine, and one part valine (“BCAA 2:1:1”) 310, L-Alanine 312, and L-Arginine 314. Powdered components of pre-blend 202 may be deposited into an intake of blender 316a. After prep-blend 318, powdered components of pre-blend 202 may comprise pre-blend 202.

While discussed with reference to the following proportion, a person having skill in the art would recognize some minor variation of the percent by weight of each component may produce similar results. Powdered component quantities may be expressed herein as percent by weight of produced pre-blend 202. Powdered components of pre-blend 202 may be deposited into the intake of blender 316a, in any order, in the following quantities: 62.17% rice 302, 16.58% tapioca 304, 12.95% cider 306, 5.18% L-Glycine 308, 1.29% BCAA 2:1:1 310, 1.29% L-Alanine 312, and 0.518% L-Arginine 314.

Other percent by weight component combinations of pre-blend 202 have been anticipated and considered acceptable for use in the formation of pre-blend 202. Quantity ranges of powdered components may also be expressed herein as percent by weight of produced pre-blend 202. Rice 302 may range from 55.95% to 68.39%. Tapioca 304 may range from 14.92% to 18.24%. Cider 306 may range from 11.65% to 14.24%. L-Glycine 308 may range from 4.66% to 5.69%. BCAA 2:1:1 310 may range from 1.16% to 1.42%. L-Alanine 312 may range from 1.16% to 1.42%. L-Arginine 314 may range from 4.6% to 5.6%. A table of values has been included in Table 1 for clarity.

TABLE 1

| | | Target % | | | Low | High | Low % | High % |
|---|---|---|---|---|---|---|---|---|
| | Component | Pre-blend | Target | Target | range | range | Pre-blend | Pre-blend |
| Name | Description | 202 | mg | grams | grams | grams | 202 | 202 |
| Rice 302 | Rice | 62.176 | 2398.334 | 2.398 | 2.159 | 2.638 | 55.958 | 68.394 |
| | Maltodexrin | | | | | | | |
| | DE10 | | | | | | | |
| Tapioca 304 | Tapioca | 16.582 | 639.622 | .640 | .576 | .704 | 14.924 | 18.240 |
| | Maltodextrin | | | | | | | |
| | DE 10 | | | | | | | |
| Cider 306 | Apple Cider | 12.953 | 499.640 | .500 | .450 | .550 | 11.658 | 14.248 |
| | Vinegar | | | | | | | |
| | Powder 5% | | | | | | | |
| L-Glycine 308 | L-Glycine | 5.181 | 199.848 | .200 | .180 | .220 | 4.663 | 5.699 |
| BCAA 310 | BCAA 2:1:1 | 1.295 | 49.952 | .050 | .045 | .055 | 1.166 | 1.425 |
| L-Alanine 312 | L-Alanine | 1.295 | 49.952 | .050 | .045 | .055 | 1.166 | 1.425 |
| L-Arginine 314 | L-Arginine | .518 | 19.981 | .020 | .018 | .022 | .466 | .570 |
| Pre-bend 202 | Pre-blend | 100 | 3857.330 | 3.857 | 3.472 | 4.243 | | |

Rice 302 may comprise any common variety of commercially available bulk Rice Maltodextrin DE 10. Rice Maltodextrin DE 10 may be an off-white free flowing powder of a particle size which may pass through a standard 100 size mesh. Rice Maltodextrin DE 10 may itself be produced by spray drying syrup extracted from brown rice grains, following a natural enzymatic treatment. Appropriately sourced Rice Maltodextrin DE 10 may be non-GMO, organic, and gluten free.

Tapioca 304 may comprise any common variety of commercially available bulk Tapioca Maltodextrin DE 10. Tapioca Maltodextrin DE 10 may be a pure white free flowing powder with a particle size which may pass through a standard 100 size mesh. Tapioca Maltodextrin DE 10 may itself be produced by spray drying syrup extracted from tapioca/cassava following a natural enzymatic treatment. Appropriately sourced Tapioca Maltodextrin DE 10 may be non-GMO, organic, and gluten free.

Cider 306 may comprise any common variety commercially available Apple Cider Vinegar powder (five % acids). Apple cider vinegar powder may be comprised of several natural organic acids. Natural organic acids found in apple cider vinegar powder may include oxalic acid, tartaric acid, malic acid, lactic acid, acetic acid, citric acid, and fumaric acid. Apple cider vinegar powder may be an off-white fine powder derived from the dehydration of apple cider vinegar with a particle size which may pass through a standard 60 size mesh(each whole approximately 250 microns in diameter). Appropriately sourced Apple Cider Vinegar powder may be non-GMO, organic, and gluten free.

L-Glycine 308 may comprise any common variety commercially available L-Glycine powder isolate. L-Glycine may be a simple, non-essential amino acid which may consist of a single carbon molecule attached to an amino and a carboxyl group. Although glycine may be isolated from hydrolyzed protein, it may be manufactured more conveniently by chemical synthesis. The two main processes are amination of chloroacetic acid with ammonia, and Strecker amino acid synthesis.

BCAA 2:1:1 310 may be a powder comprising branched chain amino acids in two parts leucine, one part isoleucine, and one part valine. BCAA 2:1:1 310 may comprise any common variety commercially available branched-chained amino acid 2:1:1 powder. Generally, a branched-chain amino acid may be an amino acid having an aliphatic side-chain with a branch formed by a central carbon atom bound to three or more additional carbon atoms. Among the proteinogenic amino acids (incorporated into biological proteins during translation) there may be three branched-chain amino acids(leucine, isoleucine, and valine). Leucine, isoleucine, and valine may be among the nine essential amino acids for humans filling several metabolic and physiological roles.

L-Alanine 312 may comprise predominately the L-isomer of two enantiomers of Alanine. L-Alanine 312 may comprise any common variety commercially available predominately the L-isomer Alanine powder. Generally, L-Alanine may comprise a white, crystalline powder of any common variety commercially available. L-Alanine may be a nonessential amino acid incorporated in into proteins in a human body. In mammals, alanine may serve a physiological function in the glucose-alanine cycle enabling glutamate and pyruvate to be removed from muscle and transported to the liver to regenerate glucose.

L-Arginine 314 may comprise predominately the L-isomer of two enantiomers of Arginine. L-Arginine 314 may comprise any common variety commercially available predominately the L-isomer Arginine powder. Generally, L-Arginine may comprise a white, crystalline powder of any common variety commercially available. Arginine may be classified as an essential or semi-essential amino acid depending on the development stage and health of the individual. Arginine may be found in the body at the active site of proteins and enzymes, used to dispose of ammonia, make further compounds, as part of the urea cycle, and may be converted to glucose and glycogen if needed.

Component powders of pre-blend 202 may be deposited into the intake of blender 316a in any order, and thereafter may undergo pre-blend 202. The scale of production, and quantities of powders to be blended, may be of primary consideration when making a choice of model for use as each blender 316. A non-exhaustive list of potential choices of blender 316 may include various models of: ribbon blenders by Aaron, J. H. Day, Paul Abbe, ProQuip, Redco, Robinson, Sprout Waldron, Strong Scott, Will Flow, or Young; double ribbon blenders by Patterson Kelly, or Ross; and paddle mixers by Davis, Kelly, Marion, Purnell, Henschel, or Desoto.

Prep-blend 318 may comprise action, or actions, of blender 316a on separate powdered components 302-314 of pre-blend 202. Prep-blending 318 may occur approximately continuously for approximately twelve minutes, or such time as to create an approximately homogenous powder mixture. Prep-blend 318 may alternatively occur in pulses (short bursts), or any other variations of action(s) different in number or duration used to effectuate a homogenous blend from components 302-314 placed therein. Prep-blend 318 may be complete once powdered components 302-314 have become a homogenous blend which thereafter may be referred to as pre-blend 202.

FIG. 4 depicts a diagrammatic representation of Step 2 of a method production of a disclosed hydration composition which may be referred to as ElectraCell 102(introduced in FIG. 1). ElectraCell 102 may be formed from a pure H₂O water facilitated agglomeration process (“agglomeration”) 204. ElectraCell 102 may be an agglomerate formed from a blend of distinct particulate components of pre-blend 202. The phrase ‘pure H₂O water’ may be used herein to describe a material, in any state of matter, comprising predominantly oxygen hydride consisting of an oxygen atom covalently bonded to two hydrogen atoms (H₂O), with a level of contaminates below that which is generally understood by those practicing the art to facilitate particle agglomeration processes.

Agglomeration 204(introduced in FIG. 2) may comprise Step 2 of a method for production of hydration blend B 104. Pre-blend enlarged view (“blend view”) 402 illustrates pre-blend 202 as a collection of distinct particles. ElectraCell enlarged view (“ElectraCell view”) 404 illustrates agglomerate particles of pre-blend 202 as a collection of approximately homogenous agglomerate particles of ElectraCell 102. Blend view 402 may be before agglomeration 204, and ElectraCell view 404 may be after agglomeration 204.

Note, powdered components 302-314 patterns used in FIG. 3 are intended for the illustration of the individual particle nature of each component in blend view 402. Likewise powdered components 302-314 patterns used in FIG. 3 are intended for the illustration of the composite nature of ElectraCell 102 shown in ElectraCell view 404 and throughout. Sizes of each particle component 302-314 found in views 402-404, and specific orientation of component particles in depictions of ElectraCell 102 have been selected for illustration purposes only, and should not be viewed as limiting.

Agglomeration-facility 400 (introduced in discussion of production facility 200 of FIG. 2) may be an environment suitable for the production of approximately homogenous agglomerate powders. Agglomeration-facility 400 may include one or more means of affecting pure H₂O water facilitated agglomeration of pre-blend 202. Generally, agglomeration may occur by particles sticking to one another or solid surfaces. Size enlargement through agglomeration may be one of several core operations in mechanical process powder engineering, and bulk solid technologies. Through agglomeration individual particles may become agglomerates by forming various connections between the particles. The new entity or agglomerate may be formed of unaltered component particles held together by various binding mechanisms.

Agglomerates may feature porosity (void spaces between agglomerate-forming particles) as a part of the agglomerate structure. Porosity may be a beneficial feature of easily dispersible food granules and catalyst carriers. Porosity may allow for infusion of smaller particles within the pores of the agglomerate structure.

Generally, three primary agglomeration processes practiced in the art may include tumble/growth agglomeration, pressure agglomeration, and agglomeration using heat. Agglomeration processes may consist of the transportation and collision of particles, attachment of particles to one another, and disruption or cementation of the attached particles. Persons having skill in the art recognize various industry standard agglomeration processes may be used in the production of agglomerate powders. Generally, agglomeration may begin by spraying powder particles in a moistening phase, allowing formation of a liquid bridge between powder particles. The powder particles may then solidify into an agglomerate as the liquid bridge gives way to the formation of connections between each particle. Some agglomeration processes utilize additional binders to facilitate these processes.

Agglomeration 204 may be accomplished by the use of pure water H₂O without incorporation of additional binders. Agglomeration processes utilizing pure water H₂O without additional binders may utilize particular properties of component particles to allow for formation of stable agglomerate particles. Benefits of agglomeration processes utilizing H₂O without the addition of binders may include production of very ‘clean’ products. No additional binders may be carried into any solution which may eventually be produced from the agglomerate particles.

Persons having skill in the art recognize particulate powder materials may be challenging to work with, for many reasons, including difficulty in handling and storage. Fine particles may also become airborne causing potential health issues. Agglomeration processes allow agglomerates of particles larger in size than component particles. Agglomerates may allow for a more manageable production environment, wherein agglomerates may be more easily handled and stored than composite particulate powder materials. Further, powder agglomeration may allow for control of particle characteristics including: bulk density, particle size distribution, product formulation, porosity, moisture content, green strength (final tensile strength), dry crush strength, particle attrition (fragmentation, breakage, fines generation), and flowability. Additionally, benefits of improved flowability may include easier more precise metering, and less lost product as dust.

FIG. 5 depicts a diagrammatic representation of Step 3 of a method of production of a disclosed hydration composition. While discussed as a third step of a method of production, persons having skill in the art would recognize production of hydration blend A 206 may occur before, or after, preparation of pre-blend 202, or formation of ElectraCell 106. Of importance is production of hydration blend A 206 prior to addition 602(discussed in relation to FIG. 6).

Ablend-facility 500 (introduced in discussion of production facility 200 of FIG. 2) may be preparation-facility 300, an adjacent environment, or entirely separate environment likewise suitable for the blending and/or production of approximately homogenous powders. Ablend-facility 500 may include blender 316b (introduced in discussion of blender 316 of FIG. 3), and distinct powdered blend components 502-520 of hydration blend A 206. Ablend-facility 500 may also include flavorings and or extracts (“flavorings”) 522 in some embodiments of hydration blend A 206. Micronutrients 501 and flavorings 522 (if any) may be deposited into the intake of blender 316b in any order and may thereafter undergo A-blend 524.

Distinct powdered components 502-520 of hydration blend A 206 may include sea salt (“salt”) 502, Trisodium Citrate Dihydrate (“Trisodium”) 504, Magnesium Bisglycinate Chelate 10% Mg (“Magnesium”) 506, Potassium Citrate (“Potassium”) 508, Calcium Bisglycinate Chelate 18% Ca (“Calcium”) 510, Vitamin B3 (“B3”) 512, Vitamin B5 (“B5”) 514, Vitamin B6 (“B6”) 516, Vitamin B2 (“B2”) 518, Vitamin B12 (“B12”) 520. Salt 502, Trisodium 504, Magnesium 506, Potassium 508, Calcium 510, B3 512, B5 514, B6 516, B2 518, B12 520, may collectively be referred to as micronutrients 501.

Micronutrients 501 and flavorings 522 quantities may be expressed herein as percent by weight of produced hydration blend B 104. While discussed with reference to the following proportion, a person having skill in the art would recognize that some minor variation of the percent by weight of each component may produce similar results. For example, in most circumstances flavorings 522 may be omitted to achieve an embodiment of a disclosed hydration composition without changing the relative proportions of micronutrients 501. Additionally, other percent by weight component combinations of hydration blend B 104 have been anticipated, and considered acceptable for use in the formation of hydration blend A 206. A table of values has been included in Table 2 for clarity.

TABLE 2

| | | Target % of | | | | | Low % | High % |
|---|---|---|---|---|---|---|---|---|
| | | hydration | | | Low | High | hydration | hydration |
| | Component | blend B | Target | Target | range | range | blend B | blend B |
| Name | Description | 104 | mg | grams | grams | grams | 104 | 104 |
| ElectraCell 102 | ElectraCell | 62.215 | 3857.33 | 3.857 | 3.471 | 4.243 | 55.993 | 68.436 |
| Salt 502 | Sea Salt | 12.089 | 749.518 | .749 | .674 | .824 | 10.880 | 13.298 |
| Trisodium 504 | Trisodium | 6.028 | 373.736 | .374 | .336 | .411 | 5.425 | 6.631 |
| | Citrate | | | | | | | |
| | Dihydrate | | | | | | | |
| Magnesium 506 | Magnesium | 4.352 | 269.824 | .270 | .242 | .297 | 3.917 | 4.787 |
| | Bisglycinate | | | | | | | |
| | Chelate 10% | | | | | | | |
| | MG | | | | | | | |
| Potassium | Potassium | 2.273 | 140.926 | .141 | .126 | .155 | 2.046 | 2.501 |
| Citrate 508 | Citrate | | | | | | | |
| Calcium 510 | Calcium | 1.209 | 74.958 | .075 | .067 | .082 | 1.088 | 1.323 |
| | Bisglycinate | | | | | | | |
| | Chelate 18% | | | | | | | |
| | Ca | | | | | | | |
| B3 512 | Vitamin B3 | .355 | 22.010 | .022 | .019 | .024 | .319 | .391 |
| B5 514 | Vitamin B5 | .161 | 9.982 | .010 | .008 | .011 | .145 | .177 |
| B6 516 | Vitamin B6 | .037 | 2.294 | .002 | .002 | .003 | .033 | .041 |
| B2 518 | Vitamin B2 | .032 | 1.984 | .002 | .002 | .002 | .029 | .035 |
| B12 520 | Vitamin B12 | .00002 | .001 | .000001 | N/A | N/A | .000018 | .000028 |
| Flavorings 522 | | 11.249 | 697.438 | .697 | .627 | .767 | 10.124 | 12.373 |
| Hydration | | 100 | 6200 | 6.200 | | | 5.460 | 6.820 |
| Blend B 104 | | | | | | | | |

Micronutrients 501 and flavorings 522 of hydration blend A 206 may be deposited, in the following quantities, into the intake of blender 316b: 12.089% salt 502, 6.028% Trisodium 504, 4.352% Magnesium 506, 2.273% Potassium 508, 1.209% Calcium 510, 0.355% B3 512, 0.161% B5 514, 0.037% B6 516, 0.032% B2 518, 0.00002% B12 520, and 11.249% Flavorings 522. Citric acid 524 if present, may be of a quantity so as to form 4.835% by weight of hydration blend B 104. Micronutrients 501 and flavorings 522 used to produce hydration blend A 206 may be deposited in into blender 316b in any order.

Quantity ranges of micronutrients 501 and flavorings 522 may be expressed herein as percent by weight of produced hydration blend B 104. Other combinations of micronutrients 501 and flavorings 522 have been anticipated, and considered acceptable for use to form hydration blend A 206. Examples may include the following percent by weight ratios. Salt 502 may range from 10.880% to 13.298%. Trisodium 504 may range from 5.425% and 6.631%. Magnesium 506 may range from 3.917% to 4.787%. Potassium 508 may range from 2.046% to 2.500%. Calcium 510 may range from 1.088% to 1.32%. B3 512 may range from 0.319% to 0.390%. B5 514 may range from 0.145% to 0.177%. B6 516 may range from 0.033% to 0.041%. B2 518 may range from 0.029% 0.035%.

Amounts of B12 520 used in production of hydration blend B 104 may vary at insignificant levels when considered as a percentage of produced hydration blend B 104, for example ranging from 0.000018% to 0.000028% of produced hydration blend B 104. Salt 502 may have a granulometry comprising fine grains (having a low average of 0.3 mm and high average of 1.0 mm). Granulometry may be used herein to refer to the measurement of the size distribution of particulates in a component particulate matter powder. Remaining micronutrients 501, and flavorings 522, may also be comprised of fine grain or smaller granulometry dimensions.

Flavorings 522 may comprise one or more ingredients acting as flavor sources. In some embodiments, flavorings 522 may include Citric Acid 524 (not shown). Flavorings 522 may include powdered natural juices and extracts in addition to Citric Acid 524. Generally, flavorings may provide user 114 a better experience while they drink 116 solution 112, otherwise flavorings 522 may not be intended to provide effect on solution 112, or user 114. Flavorings 522 may be of differing amounts of specific component ingredients so as to provide differing flavor profiles to user 114 while user 114 may drink 116 solution 112. The sum of powdered components comprising flavorings 522 may range from 10.124 to 12.373 percent of hydration blend B 104.

Citric acid 524, if present, may be of a quantity so as to form 4.835% by weight of hydration blend B 104. Citric acid 524, if used, may range between 4.351% to 5.319% by weight of hydration blend B 104. In those embodiments, citric acid 524 may be considered as either a member of micronutrients 501, or flavorings 522. Citric acid 524 may comprise any common variety commercially available citric acid powder. Generally, citric acid may be a weak organic acid occurring naturally in citrus fruit, and may act as an intermediate in the citric acid metabolic cycle.

Salt 502 may comprise commercially available food quality fine grain sea salt. Fine grain sea salt may be a white, crystalline powder produced from the evaporation of sea water. Salt 502 may be comprised of approximately 60% Chloride and 39.50% Sodium or 99.5% Sodium Chloride. Additional trace materials which may be found in salt 502 may include 0.01% Calcium, less than 0.03% Iodine, 0.02% Magnesium, 0.01% Potassium, 0.13% insoluble material, and 0.10% moisture. Sodium may be used in the human body to conduct nerve impulses, contract and relax muscles and maintain balances of water and mineral levels. Chloride may be used in the human body to regulate transfer of fluids and nutrients within cells.

Trisodium Citrate Dihydrate 504 may comprise a commercially available tribasic salt of citric acid powder. Generally, Trisodium Citrate Dihydrate may comprise a white crystalline powder, or granular crystal. Sodium citrate dihydrate may be formed by the dehydration of trisodium citrate. Trisodium citrate dihydrate may have a role in buffering chemical systems, medical anticoagulants, and urine alkalization for the prevention of kidney stones.

Magnesium 506 may comprise a commercially available chelated form of Magnesium Bisglycinate powder, and may be comprised of 10% Magnesium. Chelation may be a type of chemical reaction using chelating agents to block a reactive site of a metal ion to prevent normal metal ion reactions. Chelated minerals may be absorbed better during digestion than minerals which have not undergone chelation. Magnesium bisglycinate may be an efficient highly absorbable form of dietary magnesium easily digested independent of the general pH levels in the GI tract. Magnesium may be an essential mineral and may support muscle function, nerve function, and energy production.

Potassium Citrate 508 may comprise a commercially available potassium salt of citric acid powder. Generally, potassium citrate may comprise a white crystalline powder. Potassium citrate may be synthesized by the neutralization of citric acid through the addition of potassium bicarbonate, potassium carbonate, or potassium hydroxide. Potassium citrate may be a urinary alkalinizer allowing kidneys to more readily remove uric acid, and may be used to prevent kidney stones. Potassium may help keep body fluids in balance, regulate acidity, blood pressure, and neuromuscular function.

Calcium 510 may comprise a commercially available chelated form of Calcium Bisglycinate powder, and may be comprised of 18% Calcium. Calcium Bisglycinate may be a highly absorbable, efficient way of adding calcium to the diet. Calcium may be an essential mineral with a wide range of biological functions supporting healthy weight management, transporting nutrients throughout the body, maintaining healthy blood pressure, and building healthy bones and teeth.

B3 512 may comprise a commercially available powdered water-soluble vitamin niacin/nicotinic acid. Generally, niacin may help to promote skin, nervous system, and digestive health. Niacin/nicotinic acid may comprise a white crystalline powder.

B5 514 may comprise a commercially available powdered water-soluble vitamin Calcium D-Pantothenate. Generally, pantothenate may play a role breaking down fats and carbohydrates for energy, manufacture of red blood cells, and hormones produced by the adrenal glands. Calcium D-Pantothenate may comprise a white to off-white crystalline powder.

B6 516 may comprise a commercially available powdered water-soluble vitamin Pyridoxine in the form of Pyridoxine Hydrochloride. Pyridoxine may help to promote health in the skin, nervous system, and red blood cells. Pyridoxine Hydrochloride may comprise a white to practically white crystalline powder.

B2 518 may comprise a commercially available powdered water-soluble vitamin riboflavin in a phosphate sodium salt form. Generally, riboflavin may reduce oxidative stress and nerve inflammation and contribute to normal mitochondrial activities. Riboflavin Phosphate Sodium may comprise a yellow, or yellow to orange hygroscopic solid powder.

B12 520, may comprise a commercially available manufactured version of powdered vitamin B12 Cyanocobalamin. Generally, vitamin B12 may be a nutrient used in the body to promote healthy blood, nerve cells, and DNA. Cyanocobalamin may comprise a red to purplish red, crystalline powder.

Blender 316b may comprise blender 316a, 316c, both, or neither. Once micronutrients 501 and flavorings 522 have been placed into blender 316b, A-blend 524 may occur. A-blend 524 may occur approximately continuously for approximately twelve minutes, or such time as to create an approximately homogenous powder mixture. Similar to prep-blend 318(discussed in FIG. 3), A-blend 524 may alternatively occur in pulses (short bursts), or any other variations of action(s) different in number or duration resulting in an approximately homogenous powder mixture. A-blend 524 may be complete once powdered components 502-522 become a homogenous blend, thereafter referred to as hydration blend A 206.

FIG. 6 depicts a diagrammatic representation of Step 4 of a method of production of a disclosed hydration composition. Shortblend-facility 600 (introduced in discussion of FIG. 2) may contain hydration blend A 206, blender 316c, and ElectraCell 102. Blender 316c (introduced in discussion of blender 316 of FIG. 2) may comprise blender 316a, 316b, both, or neither.

Hydration blend A 206 at the completion of A-blend 524 may remain in blender 316b, wherein blender 316b and blender 316c comprise the same equipment. Alternatively, hydration blend A 206 may be transferred from blender 316b to blender 316c. Once hydration blend A 206 is deposited into blender 316c, blender 316c may act upon hydration blend A 206 to coat 601 blender 316c.

Coat 601 may comprise operation of blender 316c for one or more cycle(full rotation of internal components) acting upon hydration blend A 206. Coat 601 need not occur when blender 316b and blender 316c comprise the same equipment. Coat 601 may allow for hydration blend A 206 to contact the interior surfaces of blender 316c.

At the completion of coat 601, or A-blend 524, addition 602 of ElectraCell 102 may occur. Addition 602 may comprise depositing ElectraCell 102 into blender 316c. Depositing ElectraCell 102 into blender 316c may allow for ElectraCell 102 to rest among hydration blend A 206. After addition 602 of ElectraCell 102 into blender 316c among hydration blend A 206, blender 316c may short-blend 606.

Short-blend 606 may comprise actions of blender 316c upon hydration blend A 206 and ElectraCell 102. Short-blend 606 may occur approximately continuously for approximately four minutes, or such time as to create an approximately homogenous powder mixture. Similar to prep-blend 318(discussed in FIG. 3), and A-blend 524(discussed in FIG. 5), short-blend 606 may alternatively occur in pulses (short bursts), or any other variations of action(s) different in number or duration resulting in creation of an approximately homogenous powder mixture. Short-blend 606 may be complete once powdered components, hydration blend A 206 and ElectraCell 102, become a homogenous blend thereafter referred to as hydration blend B 104. Upon completion of short-blend 606 visual inspection of mixture may reveal a lack of fine powder comprising hydration blend A 206, among the infused ElectraCell 202.

It will be apparent to those skilled in the art that various modifications and variations may be made to the disclosed composition and methods. Other examples will be apparent to those skilled in the art from consideration of the specification and practice of the disclosed composition and methods. It is intended that the specification and examples be considered as illustrative only, with a true scope being indicated by the following claims and their equivalents.

What is claimed is:

1) A method of producing an approximately homogenous hydration micronutrient delivery compound comprising
a) preparation of an approximately homogenous pre-blend powder comprising
i) addition of pre-blend powder components of said pre-blend powder to intake of a powder blending apparatus
(1) said pre-blend powder components comprising
(a) Rice Maltodextrin, in amounts ranging from approximately 55.958% to approximately 68.394% weight of prepared pre-blend powder
(b) Tapioca Maltodextrin, ranging from approximately 14.924% to approximately 18.240% weight of prepared pre-blend powder
(c) Apple Cider Vinegar Powder, in amounts ranging from approximately 11.658% to approximately 14.248% weight of prepared pre-blend powder
(d) L-Glycine, in amounts ranging from approximately 4.663% to approximately 5.699% weight of prepared pre-blend powder
(e) BCAA, in amounts ranging from approximately 1.166% to approximately 1.425% weight of prepared pre-blend powder
(f) L-Alanine, in amounts ranging from approximately 1.166% to approximately 1.425% weight prepared pre-blend powder
(g) L-Arginine, in amounts ranging from approximately 0.466% to approximately 0.560% of weight prepared pre-blend powder
ii) mechanical mixing action by said powder blending apparatus upon component powders of said pre-blend powder until formation of an approximately homogenous pre-blend powder
b) and formation of an approximately homogenous agglomerate particulate powder by pure water agglomeration of said approximately homogenous agglomerate particulate powder.

2) A method of producing a hydration compound comprising the method of claim 1, and further comprising
a) production of an approximately homogenous infusing powder blend comprising
i) addition of infusing powder blend components to intake of a powder blending apparatus
(1) said infusing blend components comprising
(a) Sea Salt, in amounts ranging from approximately 10.880% to approximately 13.298% weight of infused agglomerated compound
(b) Trisodium Citrate Dehydrate, in amounts ranging from approximately 5.425% to approximately 6.631% weight of infused agglomerated compound
(c) Magnesium Bisglycinate Chelate, in amounts ranging from approximately 3.917% to approximately 4.787% weight of infused agglomerated compound
(d) Potassium Citrate, in amounts ranging from approximately 2.046% to approximately 2.500% weight of infused agglomerated compound
(e) Calcium Bisglycinate Chelate, in amounts ranging from approximately 1.088% to approximately 1.330% weight of infused agglomerated compound
(f) Vitamin B3, in amounts ranging from approximately 0.319% to approximately 0.391% weight of infused agglomerated compound
(g) Vitamin B5, in amounts ranging from approximately 0.145% to approximately 0.177% weight of infused agglomerated compound
(h) Vitamin B6, in amounts ranging from approximately 0.033% to approximately 0.041% weight of infused agglomerated compound
(i) Vitamin B2, in amounts ranging from approximately 0.029% to approximately 0.035% weight of infused agglomerated compound
(j) Vitamin B12, in amounts ranging from approximately 0.000018% to approximately 0.000028% by weight of infused agglomerated compound
(k) Flavoring, in amounts ranging from approximately 10.124% to approximately 12.374% by weight of infused agglomerated compound
ii) mechanical mixing action by said powder blending apparatus upon component powders of said infusing powder blend until formation of an approximately homogenous infusing powder
b) addition of said agglomerate particulate powder of claim 1, in amounts ranging from approximately 55.993% to approximately 68.436% weight of infused agglomerated compound, to intake of a powder blending apparatus, among said infusing powder blend
c) and infusion of said infusing powder blend among said agglomerate particulate
i) said infusion comprising mechanical mixing actions upon said agglomerate particulate powder among said pre-blend powder of a duration required to form an approximately homogonous infused agglomerated powder compound.

3) A method of producing a hydration compound comprising the method of claim 1, and further comprising
a) production of an approximately homogenous infusing powder blend comprising
i) addition of infusing powder blend components to intake of a powder blending apparatus
(1) said infusing blend components comprising
(a) Sea Salt, in amounts ranging from approximately 11.428% to approximately 16.159% weight of infused agglomerated compound
(b) Trisodium Citrate Dehydrate, in amounts ranging from approximately 5.627% to approximately 8.178% weight of infused agglomerated compound
(c) Magnesium Bisglycinate Chelate, in amounts ranging from approximately 4.048% to approximately 5.928% weight of infused agglomerated compound
(d) Potassium Citrate, in amounts ranging from approximately 2.105% to approximately 3.113% weight of infused agglomerated compound
(e) Calcium Bisglycinate Chelate, in amounts ranging from approximately 1.117% to approximately 1.660% weight of infused agglomerated compound
(f) Vitamin B3, in amounts ranging from approximately 0.319% to approximately 0.391% weight of infused agglomerated compound
(g) Vitamin B5, in amounts ranging from approximately 0.149% to approximately 0.222% weight of infused agglomerated compound
(h) Vitamin B6, in amounts ranging from approximately 0.0341% to approximately 0.051% weight of infused agglomerated compound
(i) Vitamin B2, in amounts ranging from approximately 0.030% to approximately 0.044% weight of infused agglomerated compound
(j) Vitamin B12, in amounts ranging from approximately 0.000018% to approximately 0.000028% weight of infused agglomerated compound
ii) mechanical action of said powder blending apparatus upon component powders of said infusing powder blend until formation of an approximately homogenous infusing powder
b) addition of said agglomerate particulate powder of claim 1, in amounts ranging from approximately 65.733% to approximately 74.131% weight of infused agglomerated compound, to intake of a powder blending apparatus, among said infusing powder blend
c) and infusion of said infusing powder blend among said agglomerate particulate powder
i) said infusion comprising mechanical mixing actions upon said agglomerate particulate powder among said pre-blend powder of a duration required to form an approximately homogonous infused agglomerated powder compound.

4) A method of producing a hydration compound comprising the method of claim 1, and further comprising
a) production of an approximately homogenous infusing powder blend comprising
i) addition of infusing powder blend components to intake of a powder blending apparatus
(1) said infusing blend components comprising
(a) Sea Salt, in amounts ranging from approximately 10.880% to approximately 13.298% weight of infused agglomerated compound
(b) Trisodium Citrate Dehydrate, in amounts ranging from approximately 5.425% to approximately 6.631% weight of infused agglomerated compound
(c) Magnesium Bisglycinate Chelate, in amounts ranging from approximately 3.917% to approximately 4.787% weight of infused agglomerated compound
(d) Potassium Citrate, in amounts ranging from approximately 2.046% to approximately 2.500% weight of infused agglomerated compound
(e) Calcium Bisglycinate Chelate, in amounts ranging from approximately 1.088% to approximately 1.330% weight of infused agglomerated compound
(f) Vitamin B3, in amounts ranging from approximately 0.319% to approximately 0.391% weight of infused agglomerated compound
(g) Vitamin B5, in amounts ranging from approximately 0.145% to approximately 0.177% weight of infused agglomerated compound
(h) Vitamin B6, in amounts ranging from approximately 0.033% to approximately 0.041% weight of infused agglomerated compound
(i) Vitamin B2, in amounts ranging from approximately 0.029% to approximately 0.035% weight of infused agglomerated compound
(j) Vitamin B12, in amounts ranging from approximately 0.000018% to approximately 0.000028% weight of infused agglomerated compound
(k) Flavoring, in amounts ranging from approximately 10.124% to approximately 12.374% weight of infused agglomerated compound
(i) said flavoring comprising Citric Acid, in amounts ranging from approximately 4.351% to approximately 5.318% weight of infused compound
ii) mechanical action of said powder blending apparatus upon component powders of said infusing powder blend until formation of an approximately homogenous infusing powder
b) addition of said agglomerate particulate powder of claim 1, in amounts ranging from approximately 55.993% to approximately 68.436% weight of infused agglomerated compound, to intake of a powder blending apparatus, among said infusing powder blend
c) and infusion of said infusing powder blend among said agglomerate particulate
i) said infusion comprising mechanical mixing actions upon said agglomerate particulate powder among said pre-blend powder of a duration required to form an approximately homogonous infused agglomerated powder compound.

5) A method of producing a hydration compound comprising the method of claim 2
a) and combination of said approximately homogonous infused agglomerated powder compound, to a drinkable liquid comprising potable water of a sufficient amount so as to allow dissolution and suspension of said approximately homogonous infused agglomerated powder compound
i) said infused agglomerated powder compound amount ranging from approximately 5.46 grams, to approximately 6.82 grams.

6) A method of producing a hydration compound comprising the method of claim 3
a) and combination of said approximately homogonous infused agglomerated powder compound, to a drinkable liquid comprising potable water of a sufficient amount so as to allow dissolution and suspension of said approximately homogonous infused agglomerated powder compound
i) said infused agglomerated powder compound amount ranging from approximately 5.46 grams, to approximately 6.82 grams.

7) A method of producing a hydration compound comprising the method of claim 4
a) and combination of said approximately homogonous infused agglomerated powder compound, to a drinkable liquid comprising potable water of a sufficient amount so as to allow dissolution and suspension of said approximately homogonous infused agglomerated powder compound
i) said infused agglomerated compound amount ranging from approximately 5.46 grams, to approximately 6.82 grams.

8) A method of producing a hydration compound comprising the method of claim 2
a) and packaging single servings of said approximately homogonous infused agglomerated powder compound
i) said infused agglomerated compound amounts ranging from approximately 5.46 grams, to approximately 6.82 grams.

9) A method of producing a hydration compound comprising the method of claim 3
a) and packaging single servings of said approximately homogonous infused agglomerated powder compound
i) said infused agglomerated compound amounts ranging from approximately 5.46 grams, to approximately 6.82 grams.

10) A method of producing a hydration compound comprising the method of claim 4
a) and packaging single servings of said approximately homogonous infused agglomerated powder compound
i) said infused agglomerated powder compound amounts ranging from approximately 5.46 grams, to approximately 6.82 grams.

11) A composition resulting from a process comprising
a) preparation of an approximately homogenous pre-blend powder comprising
i) addition of pre-blend powder components of said pre-blend powder to intake of a powder blending apparatus
(1) said pre-blend powder components comprising
(a) Rice Maltodextrin, in amounts ranging from approximately 55.958% to approximately 68.394% weight of prepared pre-blend powder
(b) Tapioca Maltodextrin, ranging from approximately 14.924% to approximately 18.240% weight of prepared pre-blend powder
(c) Apple Cider Vinegar Powder, in amounts ranging from approximately 11.658% to approximately 14.248% weight of prepared pre-blend powder
(d) L-Glycine, in amounts ranging from approximately 4.663% to approximately 5.699% weight of prepared pre-blend powder
(e) BCAA, in amounts ranging from approximately 1.166% to approximately 1.425% weight of prepared pre-blend powder
(f) L-Alanine, in amounts ranging from approximately 1.166% to approximately 1.425% weight prepared pre-blend powder
(g) L-Arginine, in amounts ranging from approximately 0.466% to approximately 0.560% of weight prepared pre-blend powder
ii) mechanical mixing action by said powder blending apparatus upon component powders of said pre-blend powder until causing formation of an approximately homogenous pre-blend powder
b) and formation an approximately homogenous agglomerate particulate powder by pure water agglomeration of said approximately homogenous pre-blend powder.

12) A composition of matter resulting from the process of claim 11 and a further process comprising:
a) production of an approximately homogenous infusing powder blend comprising
i) addition of infusing powder blend components to intake of a powder blending apparatus
(1) said infusing blend components comprising
(a) Sea Salt, in amounts ranging from approximately 10.880% to approximately 13.298% weight of infused agglomerated powder compound
(b) Trisodium Citrate Dehydrate, in amounts ranging from approximately 5.425% to approximately 6.631% weight of infused agglomerated powder compound
(c) Magnesium Bisglycinate Chelate, in amounts ranging from approximately 3.917% to approximately 4.787% weight of infused agglomerated powder compound
(d) Potassium Citrate, in amounts ranging from approximately 2.046% to approximately 2.500% weight of infused agglomerated powder compound
(e) Calcium Bisglycinate Chelate, in amounts ranging from approximately 1.088% to approximately 1.330% weight of infused agglomerated powder compound
(f) Vitamin B3, in amounts ranging from approximately 0.319% to approximately 0.391% weight of infused agglomerated powder compound
(g) Vitamin B5, in amounts ranging from approximately 0.145% to approximately 0.177% weight of infused agglomerated powder compound
(h) Vitamin B6, in amounts ranging from approximately 0.033% to approximately 0.041% weight of infused agglomerated powder compound
(i) Vitamin B2, in amounts ranging from approximately 0.029% to approximately 0.035% weight of infused agglomerated powder compound
(j) Vitamin B12, in amounts ranging from approximately 0.000018% to approximately 0.000028% by weight of infused agglomerated powder compound
(k) Flavoring, in amounts ranging from approximately 10.124% to approximately 12.374% by weight of infused agglomerated powder compound
ii) mechanical mixing action by said powder blending apparatus upon component powders of said infusing powder blend until formation of an approximately homogenous pre-blend powder
b) addition of said agglomerated powder compound resulting from the process of claim 11, in amounts ranging from approximately 55.993% to approximately 68.436% weight of infused agglomerated powder compound, to intake of a powder blending apparatus, among said infusing powder blend
c) and infusion of said infusing powder blend among said agglomerated powder compound
i) said infusion comprising mechanical mixing actions of said blending apparatus upon said agglomerated powder compound among said pre-blend powder of a duration required to form an approximately homogonous infused agglomerated powder compound.

13) A composition of matter resulting from the process of claim 11 and a further process comprising
a) production of an approximately homogenous infusing powder blend comprising
i) addition of infusing powder blend components to intake of a powder blending apparatus
(1) said infusing blend components comprising
(a) Sea Salt, in amounts ranging from approximately 11.428% to approximately 16.159% weight of infused agglomerated powder compound
(b) Trisodium Citrate Dehydrate, in amounts ranging from approximately 5.627% to approximately 8.178% weight of infused agglomerated powder compound
(c) Magnesium Bisglycinate Chelate, in amounts ranging from approximately 4.048% to approximately 5.928% weight of infused agglomerated powder compound
(d) Potassium Citrate, in amounts ranging from approximately 2.105% to approximately 3.113% weight of infused agglomerated powder compound
(e) Calcium Bisglycinate Chelate, in amounts ranging from approximately 1.117% to approximately 1.660% weight of infused agglomerated powder compound
(f) Vitamin B3, in amounts ranging from approximately 0.319% to approximately 0.391% weight of infused agglomerated powder compound
(g) Vitamin B5, in amounts ranging from approximately 0.149% to approximately 0.222% weight of infused agglomerated powder compound
(h) Vitamin B6, in amounts ranging from approximately 0.0341% to approximately 0.051% weight of infused agglomerated powder compound
(i) Vitamin B2, in amounts ranging from approximately 0.030% to approximately 0.044% weight of infused agglomerated powder compound
(j) Vitamin B12, in amounts ranging from approximately 0.000018% to approximately 0.000028% weight of infused agglomerated powder compound
ii) mechanical action of said powder blending apparatus upon component powders of said infusing powder blend until formation of an approximately homogenous pre-blend powder
b) addition of said agglomerated powder compound resulting from the process of claim 11, in amounts ranging from approximately 65.733% to approximately 74.131% weight of infused agglomerated powder compound, to intake of a powder blending apparatus, among said infusing powder blend
c) and infusion of said infusing powder blend among said agglomerated powder compound,
i) said infusion comprising mechanical mixing actions of said blending apparatus upon said agglomerated powder compound among said pre-blend powder of a duration required to form an approximately homogonous infused agglomerated powder compound.

14) A composition of matter resulting from the process of claim 11 and a further process comprising
a) production of an approximately homogenous infusing powder blend comprising
i) addition of infusing powder blend components to an intake of a powder blending apparatus
(1) said infusing blend components comprising,
(a) Sea Salt, in amounts ranging from approximately 10.880% to approximately 13.298% weight of infused agglomerated powder compound
(b) Trisodium Citrate Dehydrate, in amounts ranging from approximately 5.425% to approximately 6.631% weight of infused agglomerated powder compound
(c) Magnesium Bisglycinate Chelate, in amounts ranging from approximately 3.917% to approximately 4.787% weight of infused agglomerated powder compound
(d) Potassium Citrate, in amounts ranging from approximately 2.046% to approximately 2.500% weight of infused agglomerated powder compound
(e) Calcium Bisglycinate Chelate, in amounts ranging from approximately 1.088% to approximately 1.330% weight of infused agglomerated powder compound
(f) Vitamin B3, in amounts ranging from approximately 0.319% to approximately 0.391% weight of infused agglomerated powder compound
(g) Vitamin B5, in amounts ranging from approximately 0.145% to approximately 0.177% weight of infused agglomerated powder compound
(h) Vitamin B6, in amounts ranging from approximately 0.033% to approximately 0.041% weight of infused agglomerated powder compound
(i) Vitamin B2, in amounts ranging from approximately 0.029% to approximately 0.035% weight of infused agglomerated powder compound
(j) Vitamin B12, in amounts ranging from approximately 0.000018% to approximately 0.000028% weight of infused agglomerated powder compound
(k) Flavoring, in amounts ranging from approximately 10.124% to approximately 12.374% weight of infused agglomerated powder compound
(i) said flavoring comprising Citric Acid, in amounts ranging from approximately 4.351% to approximately 5.318% weight of infused agglomerated powder compound
ii) mechanical action of said powder blending apparatus upon component powders of said infusing powder blend until formation of an approximately homogenous infusing powder
b) addition of said agglomerated powder compound resulting from the process of claim 7, in amounts ranging from approximately 55.993% to approximately 68.436% weight of infused agglomerated powder compound, to an intake of a powder blending apparatus, among said infusing powder blend
c) and infusion of said infusing powder blend among said agglomerate particulate
i) said infusion comprising mechanical mixing actions of said blending apparatus upon said agglomerate particulate powder among said infusing powder of a duration required to form an approximately uniform powdered infused agglomerated compound.

15) A composition of matter resulting from the process of claim 12 and a further process comprising
a) combination of said approximately homogonous infused agglomerated powder compound, to a drinkable liquid comprising potable water of a sufficient amount so as to allow dissolution and suspension of said approximately homogonous infused agglomerated powder compound
i) said infused agglomerated compound amount ranging from approximately 5.46 grams, to approximately 6.82 grams.

16) A composition of matter resulting from the process of claim 13 and a further process comprising
a) combination of said approximately homogonous infused agglomerated powder compound, to a drinkable liquid comprising potable water of a sufficient amount so as to allow dissolution and suspension of said approximately homogonous infused agglomerated powder compound
i) said infused agglomerated compound amount ranging from approximately 5.46 grams, to approximately 6.82 grams.

17) A composition of matter resulting from the process of claim 14 and a further process comprising
a) combination of said approximately homogonous infused agglomerated powder compound, to a drinkable liquid comprising potable water of a sufficient amount so as to allow dissolution and suspension of said approximately homogonous infused agglomerated powder compound
i) said infused agglomerated compound amount ranging from approximately 5.46 grams, to approximately 6.82 grams.

18) A method of treatment of dehydration in users comprising oral ingestion by a user of a solution comprising formerly powdered infused agglomerates as a means for affecting local changes to the osmolality of the interstitial fluid of human tissues of said user
a) said infused powdered agglomerates comprising powdered agglomerates infused with an infusing powder comprising one or more micronutrients and flavors
i) said powdered agglomerates comprising
(1) Rice Maltodextrin, in amounts ranging from approximately 55.958% to approximately 68.394% weight powdered agglomerates
(2) Tapioca Maltodextrin, ranging from approximately 14.924% to approximately 18.240% weight powdered agglomerates
(3) Apple Cider Vinegar, Powder in amounts ranging from approximately 11.658% to approximately 14.248% weight powdered agglomerates
(4) L-Glycine, in amounts ranging from approximately 4.663% to approximately 5.699% weight powdered agglomerates
(5) BCAA, in amounts ranging from approximately 1.166% to approximately 1.425% weight powdered agglomerates
(6) L-Alanine, in amounts ranging from approximately 1.166% to approximately 1.425% weight powdered agglomerates
(7) L-Arginine, in amounts ranging from approximately 0.466% to approximately 0.560% weight powdered agglomerates
b) said solution resulting from mixing 3.4716 g to 4.2431 g of said powdered agglomerates in combination with potable water.

19) A method of treatment of dehydration in users comprising the method of claim 18 wherein said infusing powder comprises
a) Sea Salt, in amounts ranging from approximately 10.880% to approximately 13.298% weight of infused powdered agglomerates
b) Trisodium Citrate Dehydrate, in amounts ranging from approximately 5.425% to approximately 6.631% weight of infused powdered agglomerates
c) Magnesium Bisglycinate Chelate, in amounts ranging from approximately 3.917% to approximately 4.787% weight of infused powdered agglomerates
d) Potassium Citrate, in amounts ranging from approximately 2.046% to approximately 2.500% weight of infused powdered agglomerates
e) Calcium Bisglycinate Chelate, in amounts ranging from approximately 1.088% to approximately 1.330% weight of infused powdered agglomerates
f) Vitamin B3, in amounts ranging from approximately 0.319% to approximately 0.391% weight infused powdered agglomerates
g) Vitamin B5, in amounts ranging from approximately 0.145% to approximately 0.177% weight infused powdered agglomerates
h) Vitamin B6, in amounts ranging from approximately 0.033% to approximately 0.041% weight infused powdered agglomerates
i) Vitamin B2, in amounts ranging from approximately 0.029% to approximately 0.035% weight infused powdered agglomerates
j) Vitamin B12, in amounts ranging from approximately 0.000018% to approximately 0.000028% weight infused powdered agglomerates
k) Flavoring, in amounts ranging from approximately 10.124% to approximately 12.374% weight infused powdered agglomerates.

20) Method of treatment of dehydration in users comprising the method of claim 18 wherein said infusing powder comprises
a) Sea Salt, in amounts ranging from approximately 11.428% to approximately 16.159% weight infused powdered agglomerates
b) Trisodium Citrate Dehydrate, in amounts ranging from approximately 5.627% to approximately 8.178% weight infused powdered agglomerates
c) Magnesium Bisglycinate Chelate, in amounts ranging from approximately 4.048% to approximately 5.928% weight infused powdered agglomerates
d) Potassium Citrate, in amounts ranging from approximately 2.105% to approximately 3.113% weight infused powdered agglomerates
e) Calcium Bisglycinate Chelate, in amounts ranging from approximately 1.117% to approximately 1.660% weight infused powdered agglomerates
f) Vitamin B3, in amounts ranging from approximately 0.319% to approximately 0.391% weight infused powdered agglomerates
g) Vitamin B5, in amounts ranging from approximately 0.149% to approximately 0.222% weight infused powdered agglomerates
h) Vitamin B6, in amounts ranging from approximately 0.034% to approximately 0.051% weight of infused powdered agglomerates
i) Vitamin B2, in amounts ranging from approximately 0.030% to approximately 0.044% weight of infused powdered agglomerates
j) Vitamin B12, in amounts ranging from approximately 0.000018% to approximately 0.000028% weight of infused powdered agglomerates.
